(19) United States
(12) Patent Application Publication
(10) Pub. No.: US 2016/0097523 A1
(43) Pub. Date: Apr. 7, 2016

(54) Lamp having a laminar heat sink, and a method for its manufacture

(71) Applicant: Microlight Systems, San Antonio, TX (US)

(72) Inventor: Ryan Waters, San Antonio, TX (US)

(21) Appl. No.: 14/504,044

(22) Filed: Oct. 1, 2014

(51) Int. Cl. F21V 29/77; F21V 29/71; F21K 99/00; F21V 7/00; F21V 8/00; F21V 29/83; F21V 29/67

(52) U.S. Cl. CPC F21V 29/773; F21V 29/83; F21V 29/713; F21V 29/67; F21V 7/0091; G02B 6/0031; F21K 9/90; F21Y 2101/02

(57) ABSTRACT

Disclosed is a lamp with a laminar heat sink assembly. The lamp includes a plurality of thermally conducting plates, each thermally conducting plate comprising a bonding portion and a heat-dissipating structure, the bonding portions of the plurality of thermally conducting plates fixed together to form a laminar block. The lamp includes a light source thermally connected to the laminar block.

### TECHNICAL FIELD

The device and methods disclosed herein relate generally to lamps, and particularly to lamps designed to dissipate waste heat efficiently.

### BACKGROUND ART

The lighting industry as a whole has undergone a huge transition, moving from halogen and incandescent light sources to more efficient light sources such as light emitting diodes (“LEDs”). In particular, there is increase interest in the employment of LEDs as light sources for theater lighting. This growth has been due in large part to the power efficiency and light output of the LEDs. Historically, the low light output from LEDs made them impractical for use in applications requiring significant light output, for example, in outdoor applications. However, as LED light output continues to increase from improvements in semiconductor and LED efficiency, LEDs are finding application in an increase number of areas.

These new light sources present different challenges to manufacturers than traditional lighting. In particular, LED lighting designs require special pains to avoid the buildup of heat in the LEDs. Unlike incandescent and halogen lights, which can operate at high temperatures, LED lighting requires effective thermal management to keep the LED within the optimal thermal envelope. Reduced efficiency, reduced lifespan, or damage to the LED units can result from extended high temperature operation. As a result, effective cooling is crucial. Typically, LED lighting designs use some form of heat exchanger transport heat away from LEDs to heat sinks, which use relatively greater mass to absorb the heat while dissipating it to air or other fluid through structures such as fins. A common drawback is that the heat sink core structures must be extruded or cast then bonded to the fins. Alternately, the entire heat sink core and fin structure can be machined from a single piece of metal. The machinery and expertise required such manufacturing is often expensive and complex, with significant investment required in tooling or CAM programming prior to production.

It common for LED lighting to be incorporated into a device designed specifically for the unique thermal profile of LED lighting. In the theater environment, this presents a number of problems. For example, a lighting unit that utilizes the lamp body as a cooling system may be unable to shed heat effectively without requiring changes to the size, mounting, or supporting components such that it is incompatible with existing lamps. Specially designed lamp bodies that incorporate LED lighting are expensive, and require replacement of the entire unit.

Therefore, there remains a need for heat dissipation designs in lighting that can be cheaply and effectively manufactured and incorporated into existing lighting structures.

### SUMMARY OF THE EMBODIMENTS

Disclosed herein is a lamp with a laminar heat sink assembly. The lamp includes a plurality of thermally conducting plates. Each thermally conducting plate includes a bonding portion and a heat-dissipating structure. The bonding portions of the plurality of thermally conducting plates are fixed together to form a laminar block. The lamp includes a light source thermally connected to the laminar block.

In a related embodiment, each bonding portion of the bonding portions of the plurality of thermally conducting plates includes a first surface and a second surface, and wherein the first surface of at least one first bonding portion is fixed against the second surface of at least one second bonding portion. In another embodiment, the first surface of the at least one first bonding portion is fused to the second surface of the at least one second bonding portion. In an additional embodiment, the plurality of bonding portions are fixed together using a plurality of fasteners. In still another embodiment, the bonding portion of each of the plurality of thermally conducting plates is substantially flat. In yet another embodiment, the at least one heat dissipation structure of each heat conducting plate includes at least one wing. In some embodiments, each wing has at least one perforation. In an additional embodiment, the wing of each thermally conducting plate projects from the laminar block at a different angle from each wing of each adjacent thermally conducting plate. In another embodiment still, the wings are displaced radially around the laminar block.

In another related embodiment, the lamp further includes a fan positioned to blow air over the at least one heat-dissipating structure of at least one of the plurality of thermally conducting plates. In a further embodiment, the light source is thermally connected to the laminar block by a heat pipe that contacts the laminar block and on which the light source is deployed. In a further embodiment still, the light source deployed against the laminar block. In another embodiment, the lamp also includes a lamp reflector shaped to focus the light from the light source. In an additional embodiment, the light source is deployed within the lamp reflector. Another embodiment of the lamp includes a light guide, the light guide including a total internal reflection conduit having a proximal end receiving substantially all light from the light source and a distal end projecting into the lamp reflector and a diffuse reflector, positioned at the distal end of the conduit, and shaped to reflect light back onto the lamp reflector. In a related embodiment, the diffuse reflector is embedded in the distal end of the conduit, and the diffuse reflector is further shaped to reflect light at an angle less than the critical angle of the conduit surface, so that the light passes through the conduit and strikes the lamp reflector. In another related embodiment the light source further includes a reflective backing shaped to direct substantially all light emitted by the light source into the proximal end of the conduit. Still another embodiment also includes a light fixture in which the light source and plurality of thermally conducting plates are incorporated.

Also disclosed is a method for manufacturing a laminar heat sink. The method includes producing a plurality of thermally conducting plates, each thermally conducting plate comprising a bonding portion and a heat-dissipating structure. The method includes fixing together the bonding portions of the plurality of thermally conducting plates to form a laminar block. An additional embodiment of the method also includes thermally connecting a light source to the laminar block.

Other aspects, embodiments and features of the disclosed device and method will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the device and method is shown where illustration is not necessary to allow those of ordinary skill in the art to understand the device and method.

### BRIEF DESCRIPTION OF THE DRAWINGS

The preceding summary, as well as the following detailed description of the disclosed device and method, will be better understood when read in conjunction with the attached drawings. It should be understood that the invention is not limited to the precise arrangements and instrumentalities shown.

FIG. 1A is a schematic diagram illustrating one embodiment of the disclosed lamp;

FIG. 1B is a schematic diagram illustrating a detail of the disclosed lamp;

FIG. 1C is a schematic diagram illustrating one embodiment of a thermally conducting plate;

FIG. 1D is a schematic diagram illustrating one embodiment of the disclosed lamp;

FIG. 1E is a partially exploded view of one embodiment of the laminar heat sink;

FIG. 1F is a cross-section of one embodiment of the disclosed lamp;

FIG. 1G is a cross-section of one embodiment of the disclosed lamp;

FIGS. 2A-2C are schematic diagrams of embodiments of the disclosed lamp as incorporated in a light fixture;

FIG. 2D is a schematic diagram of an embodiment of the disclosed lamp with a tool-less attachment device for attaching the lamp to a light fixture;

FIGS. 2E-2F are schematic diagrams of embodiments of the disclosed lamp as incorporated in a light fixture; and

FIG. 3 is a flow diagram illustrating one embodiment of the disclosed method for manufacturing a lamp.

### DETAILED DESCRIPTION OF SPECIFIC EMBODIMENTS

Embodiments of the disclosed lamp incorporate a laminar heat sink that is easy and inexpensive to manufacture. The heat sink can be readily modified to suit the needs of various different lighting solutions with minor changes to the manufacturing process. This flexibility and ease of manufacture allows the heat sink to be incorporated in special-purpose lighting, such as theater lighting, at a minimal cost.

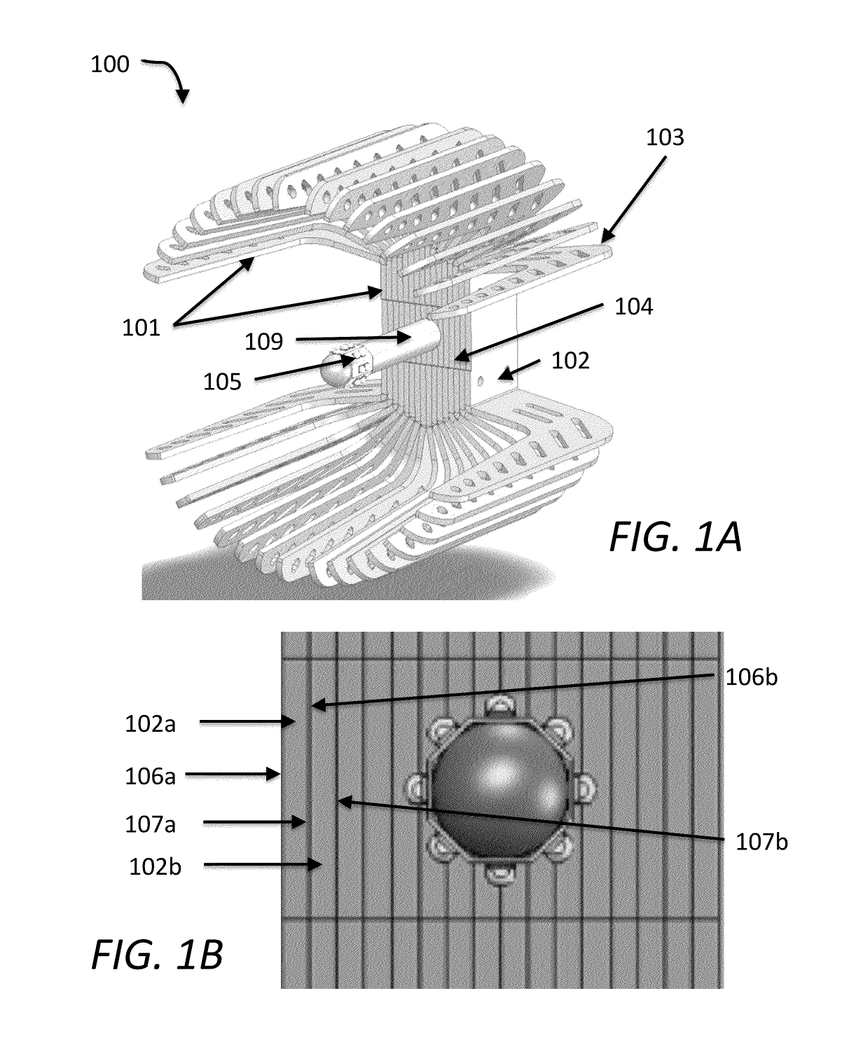

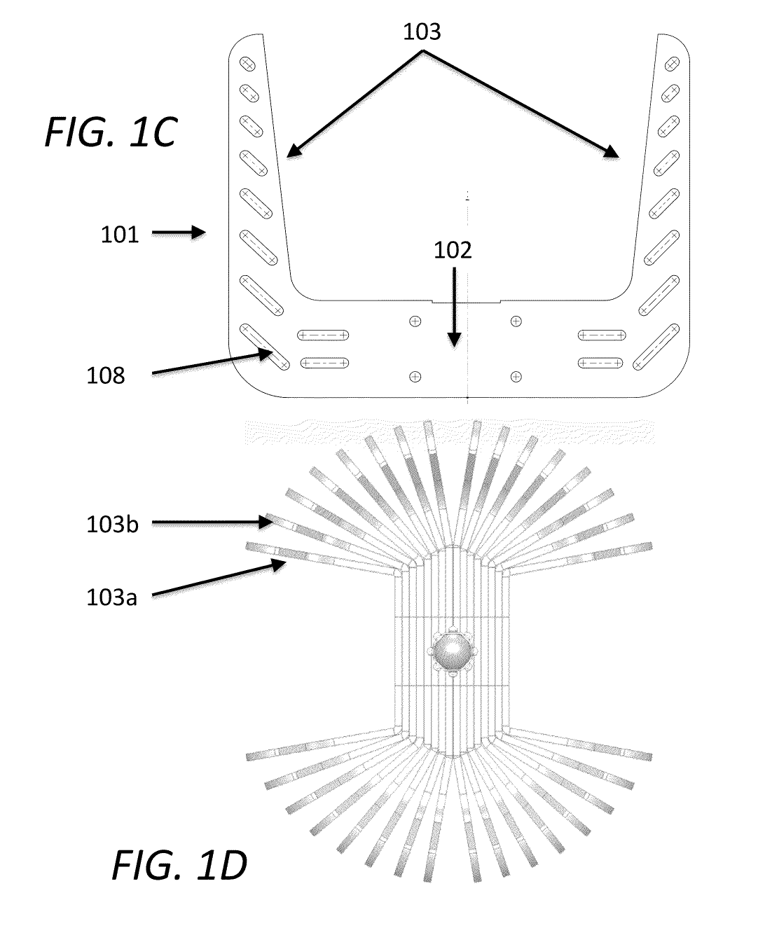

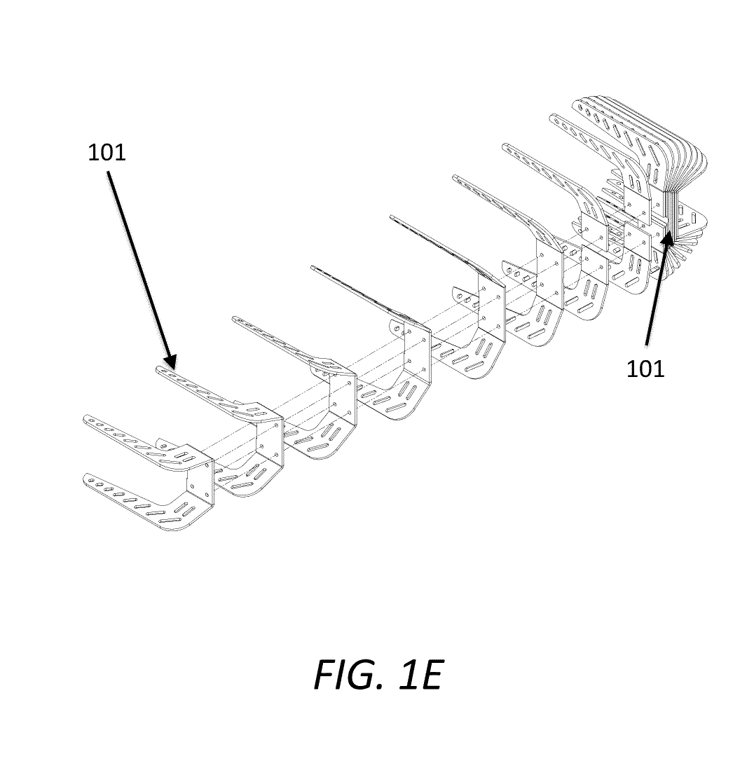

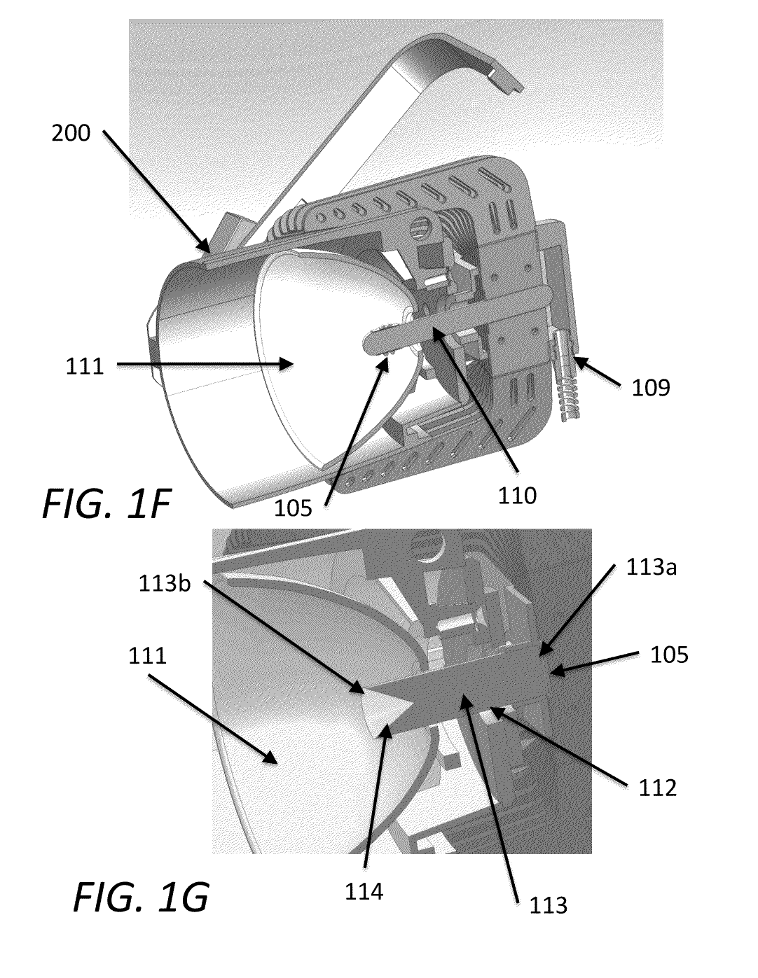

FIG. 1A illustrates one embodiment of the disclosed lamp 100. The lamp 100 includes a plurality of thermally conducting plates 101. Each thermally conducting plate has a bonding portion 102 and a heat-dissipating structure 103. The bonding portions 101 of the plurality of thermally conducting plates 101 are fixed together to form a laminar block 104. The lamp 100 also includes a light source 105 thermally connected to the laminar block 104.

Each of the thermally conducting plates 101 may be constructed from any combination of thermally conducting materials. Each thermally conducting plate 101 may be constructed of a single thermally conducting material. Each thermally conducting plate 101 may be constructed of a combination of thermally conducting materials. Each thermally conducting plate 101 may be constructed of a combination of thermally conducting materials with materials that are not thermally conducting. Each thermally conducting plate 101 may be constructed of electrically conductive materials. In some embodiments, each thermally conducting plate 101 is composed at least partly of metal. The metal may be aluminum. The metal may be steel. In some embodiments, each thermally conducting plate 101 is composed of a thermally conductive polymer material. In some embodiments, each thermally conducting plate 101 is composed of a thermally conductive ceramic. Each thermally conducting plate 101 may be composed of electrically insulating materials; for instance, Each thermally conducting plate 101 may be composed of a thermally conductive but electrically insulating ceramic. Each thermally conducting plate 101 may be composed of a thermally conductive but electrically insulating plastic or other polymer. Each thermally conducting plate 101 may be composed of a combination of electrically conducting and electrically insulating materials.

Each thermally conducting plate 101 includes a bonding portion 102. The bonding portion 102 of each plate 101 is formed so that it may be combined with the bonding portions of the other thermally conducting plates 101, of the plurality of thermally conducting plates 101, to form a laminar block 104. The laminar block 104 is composed of the bonding portions 102 of the plates 101, tightly joined to form a solid block having similar properties to a single monolithic block of thermally conducting material. As an example, as illustrated in FIG. 1A, in some embodiments, each bonding portion 102a, of the bonding portions of the plurality of thermally conducting plates includes a first surface 106a and a second surface 107a. Continuing the example, the first surface 106b of at least one first bonding portion 102b may be fixed against the second surface 107a of at least one second bonding portion 102a. The first surface 106b of the at least one first bonding portion 102b may be fused to the second surface 107a of the at least one second bonding portion 102a. The fusion may be accomplished by any suitable procedure; for instance the first surface 106b may be adhered to the second surface 107a. The first surface 106b may be welded to the second surface 107a. The first surface 106b may be brazed to the second surface 107a. In other embodiments, the plurality of bonding portions 102 are fixed together using fasteners. The fasteners may be one or more rivets. The fasteners may be one or more screws. The fasteners may be one or more bolts. The fasteners may be one or more captive fasteners. The fasteners may be one or more clamps. The fasteners may be one or more ties. Multiple plates may be joined in this manner to form the block 104. The plates may be of uniform thickness or varied thickness. The plates may be any thickness required for the particular purpose for which the lamp 100 and heat sink are intended. For instance, a lamp that requires many heat dissipation structures 103 may have thinner thermally conducting plates 101. The plates may be of uniform thickness. The plates may be of varied thickness.

In some embodiments, the bonding portions 102 are shaped so that they fit together closely to form the laminar block. The bonding portion 102 of each of the plurality of thermally conducting plates 101 may be substantially flat. In some embodiments, the bonding portions 102 are not flat, but are formed so that the first surfaces 106b have profiles that fit the profiles of the corresponding second surfaces 107a; for instance, a first surface 106b may have a protruding portion such as a ridge that fits into a corresponding depression, such as a groove, in the corresponding second surface 107a. In some embodiments, the bonding portions are formed uniformly in a way that creates reciprocal shapes, for instance by stamping identical blanks as described in further detail below. Because each thermally conducting plate 101 interfaces with at least one other thermally conducting plate 101 via the laminar block 104 to form the heat sink, thermal load may be transferred from the light source, or a conductor from the light source as described below, directly to a heat plate or the thermal load may be conducted through adjacent heat plates and dissipation of the thermal load may be effected by the heat sink as a unitary structure.

In some embodiments, at least one of the thermally conducting plates 101 has at least one heat-dissipating structure 103. In other embodiments, each of the thermally conducting plates 101 has at least one heat-dissipating structure 103. The at least one heat dissipating structure 103 may be a structure that enhances the dissipation of heat into the surrounding air by radiation and convection. The at least one heat-dissipating structure 103 may be constructed of any materials suitable for the construction of a thermally conducting plate 101; the at least one heat-dissipating structure 103 and the remainder of the thermally conducting plate 101 may be formed together as a single monolithic unit. The at least one heat-dissipating structure may function by increasing the surface area of the laminar heat sink that is exposed to the air; thus, the at least one heat-dissipating structure may be any structure that increases that surface area. The at least one heat-dissipating structure may be a fin. The at least one heat-dissipating structure may be at least one wing. By way of illustration, FIG. 1C depicts one embodiment of a thermally conducting plate 101 in which the at least one heat-dissipation structure 103 is two wings on either side of the bonding portion 102 of the thermally conducting plate. In some embodiments, at least one wing 103 has at least one perforation 108. In some embodiments, each wing 103 has at least one perforation 108. In some embodiments, the wing 103 of each thermally conducting plate projects from the laminar block at a different angle from each wing of each adjacent thermally conducting plate. For instance, as illustrated in FIG. 1D, one wing 103a may be bent at its juncture with its corresponding bonding portion 102a, forming an angle. A second wing 103b may be bent at its juncture with the corresponding bonding portion 102b, forming a second angle that differs from the first angle, so that the two wings 103a and 103b project in different directions, creating space between the wings and improving their ability to dissipate heat. In some embodiments, the wings 103 are displaced radially around the laminar block 104. For instance, the heat plates may be deformed such that the lateral wings are displaced radially between zero and 180 degrees from the central bridge, which results in air gaps between the lateral wings of the heat plates within an assembled heat sink. When connected together, the thermally conducting plates 101 form a heat sink. In one embodiment, a heat sink transfers heat between a solid object and some fluid media, which may a liquid, air or other gasses. Heat exchangers also may include some type of circulation unit such as a fan for further assisting in moving heat away from the heat-producing components. Some embodiments of the lamp 100 also include a fan positioned to blow air over the at least one heat-dissipating structure of at least one of the plurality of thermally conducting plates. FIG. 1E illustrates a partially exploded view of the heat sink assembly, showing how the thermally conducting plates 101 combine to form the laminar block 104 in one embodiment.

Referring again to FIG. 1A, in some embodiments, the lamp 100 includes a light source 105, which converts electric energy into electromagnetic radiation. The light source 105 may emit any form of electromagnetic radiation. The light source 105 may emit visible light. In one embodiment, the light source 105 includes at least one electroluminescent device, which uses the electroluminescent effect to produce at least part of its light; for instance, the light source 105 may be an LED. In another embodiment, the light source 105 produces light via the incandescent effect, for instance by heating a filament until it glows, as in an incandescent light bulb. In another embodiment, the light source 105 produces light by exciting a gas, as in a “neon” lamp. In yet another embodiment, the light source 105 includes at least one laser. In some embodiments, the light source 105 employs the use of phosphors. Some embodiments of the light source 105 emit light in part via fluorescent materials; for example, the light source 105 may produce ultraviolet light by exciting a gas, and convert it to visible light using a fluorescent material that absorbs ultraviolet light and emits visible light. As another example, the light source 105 may use the electroluminescent effect to produce visible light in one or more wavelengths while a fluorescent material in the light source 105 absorbs light in those wavelengths and releases light in another set of wavelengths. Some embodiments of the light source 105 may emit light in part via phosphorescent materials, which absorb energy and release it gradually as light; for instance, the light source 105 may release light in short pulses, which is absorbed and re-emitted more gradually by phosphorescent material, producing a smoother light output. The light source 105 may include point lights with or without a focus mechanism, or any other light source capable of projecting light onto a remote surface. The light source 105 may include a polymer light-emitting diode. The light source 105 may include an organic light-emitting diode. The light source 105 may include a solid-state laser. The light source 105 may include another solid-state light emitting device. The light source 105 may include an array of light-emitting devices as described above, connected by any suitable electric circuitry.

As shown in FIG. 1F, the at least one light source may be electrically connected to a driver circuit 109. In one embodiment, the driver circuit 109 conveys electrical power from a power source to the at least one light source 105. The power source may be any source of electrical power suitable for powering a light source 105. The power source may include an electrical outlet supplying alternating current power from a power plant. The power source may include a generator of alternating current. The power source may include a generator of direct current. The power source may include a photovoltaic panel. The power source may include a battery. The power source may include a fuel cell. In some embodiments, the driver circuit 109 is constructed as a triac dimmable driver, improving upon prior designs by eliminating the requirement of a non-dimmed power source. In the context of theater lightning retrofit capability, this driver circuit 109 may save time and money because theater operators don't have to re-run and retrofit dimmable power sources into facilities not originally designed for DMX or dimming control. The driver circuit 109 may be mounted to the rear of the heat sink assembly. Connections to theater controllers and power may be made through a control unit external to the driver circuit 109; other embodiments may employ an integral light driver and control unit.

The light source 105 is thermally connected to the laminar block 104. In one embodiment, the light source 105 is thermally connected to the laminar block 104 if there is a thermally conductive path from the light source to the laminar block 104. In some embodiments, the light source is thermally connected to the laminar block by a heat pipe 110 that contacts the laminar block and on which the light source is deployed. In one embodiment, a heat pipe 110 is an enclosed conduit that transports heat from a first heat-conducting end against a heat source to a second heat-conducting end against a heat sink, using a phase changing material; the phase-changing material absorbs heat from the first end, vaporizing in the process, travels as vapor to the second end, condenses at the second end while transferring heat to the second end, and then travels back to the first end as liquid. In some embodiments, the liquid travels by gravity. In other embodiments, the liquid travels by capillary action, through porous laser-sintered metal powder, grooves, or screens. In some embodiments, the phase-changing material is a material that is above its melting point, and below its critical temperature at either end of the heat pipe; the phase-changing material may be selected to have boiling point that allows the heat pipe to transfer the heat with maximal efficiency at the operating temperature of the light source 105. The heat pipe 110 may contact the block 104 in a manner that permits efficient heat conduction from the condensing end of the heat pipe 110 to the block 104. The contact surfaces of the block 104 and/or heat pipe 110 may be machined for optimal contact between the heat pipe 110 and the contact surface of the block 104. The contact surfaces may also be treated with coatings or compounds to improve thermal transfer, including but not limited to thermal pads, thermal paste, or thermal grease.

The light source 105 may be thermally connected to the laminar block 104 by being deployed against the laminar block 104. In some embodiments, the light source 105 is configured for contact with the block 104 such that the surface of the light source 105 is in direct or proximate contact with the laminar block 104, which allows for optimal transfer of heat from the light source 104 to the laminar block 104. As in other embodiments, the contact surfaces of the laminar block 104 may be machined for optimal contact with the thermal load, in this case being the light source 105. The contact surfaces may also be treated with coatings or compounds to improve thermal transfer, including but not limited to thermal pads, thermal paste, or thermal grease. The light source 105 may also be deployed on a projecting portion of the laminar block 104; the light source 105 may be deployed on a conducting projection deployed on the laminar block 104.

In some embodiments, as depicted in FIG. 1F, the lamp 100 includes a lamp reflector 111. The lamp reflector 111 may be shaped to focus the light from the light source 105. The lamp reflector 111 may have any form suitable for focusing the light from the light source 105 as required for the application to which the lamp 100 is directed. The lamp reflector 111 may be hemispherical. The lamp reflector 111 may be a section of a regular or irregular ellipsoid. The lamp reflector 111 may be a section of a regular or irregular polyhedron. The lamp reflector 111 may be parabolic. In some embodiments, the light source 105 is deployed within the lamp reflector 111; for instance, the light source 105 may be deployed on a projecting portion of the laminar block 104 that projects into the lamp reflector 111. The light source 105 may be deployed on a conducting object that is connected to the laminar block 104 and projects into the reflector 111. The light source 105 may be deployed on the heat pipe 110, which may project into the reflector.

In other embodiments, as shown in FIG. 1G, the light source 105 is deployed outside the reflector 111, and the light from the light source is transmitted to the reflector 111 using a light guide 112. In one embodiment, the light guide 112 includes a total internal reflection conduit 113 having a proximal end 113a receiving substantially all light from the light source and a distal end 113b projecting into the lamp reflector. The light guide 112 may include a diffuse reflector 114, positioned at the distal end 113b of the conduit, and shaped to reflect light back onto the lamp reflector. The total internal reflection conduit 113 may be a solid piece of material having a higher refractive index than the air surrounding it, causing light that strikes it at greater than a critical angle from the line normal to the surface at the point the light strikes it to be reflected entirely within the conduit 113. The refractive index of the conduit 113 may be chosen so that substantially all of the light that the light source shines into the conduit 113 is transmitted to the end of the conduit 113 by total internal reflection. The conduit 113 may be cylindrical. The lamp 100 may include a reflective backing shaped to direct substantially all light emitted by the light source 105 into the proximal end 113a of the conduit 113.

The diffuse reflector 114 may be embedded in the distal end 113b of the conduit, and wherein the diffuse reflector is further shaped to reflect light at an angle less than the critical angle of the conduit surface, so that the light passes through the conduit and strikes the lamp reflector. The diffuse reflector 114 may be conical, with its apex pointing toward the proximal end 113a of the conduit 113; light reflecting down the conduit 113 will thus reflect off the reflector 114 at an angle steeper than the critical angle, passing through the walls of the conduit 113 and shining onto the lamp reflector 111. As a result, the light guide 112 may act as a diffuse reflector to match original dispersal characteristics of a tungsten filament. In a typical tungsten filament lamp, the original light has two focal points at the reflector and at the gate. Whereas common lamps can only collect about 65% of light emitted from a tungsten filament, the lamp 100 with the light guide 112 may retain more collection onto the reflector because there is no light loss in directions not striking the reflector. In some embodiments, this provides a more consistent radiation pattern because multi-filament obstruction doesn't occur as it would in a traditional four element tungsten lamp. The diffuse reflector 114 that is embedded in the distal end 113b of the conduit 113 may contribute to improvement of the diffusion pattern by avoiding an air gap. The light guide may employ a silicon diffuse reflector.

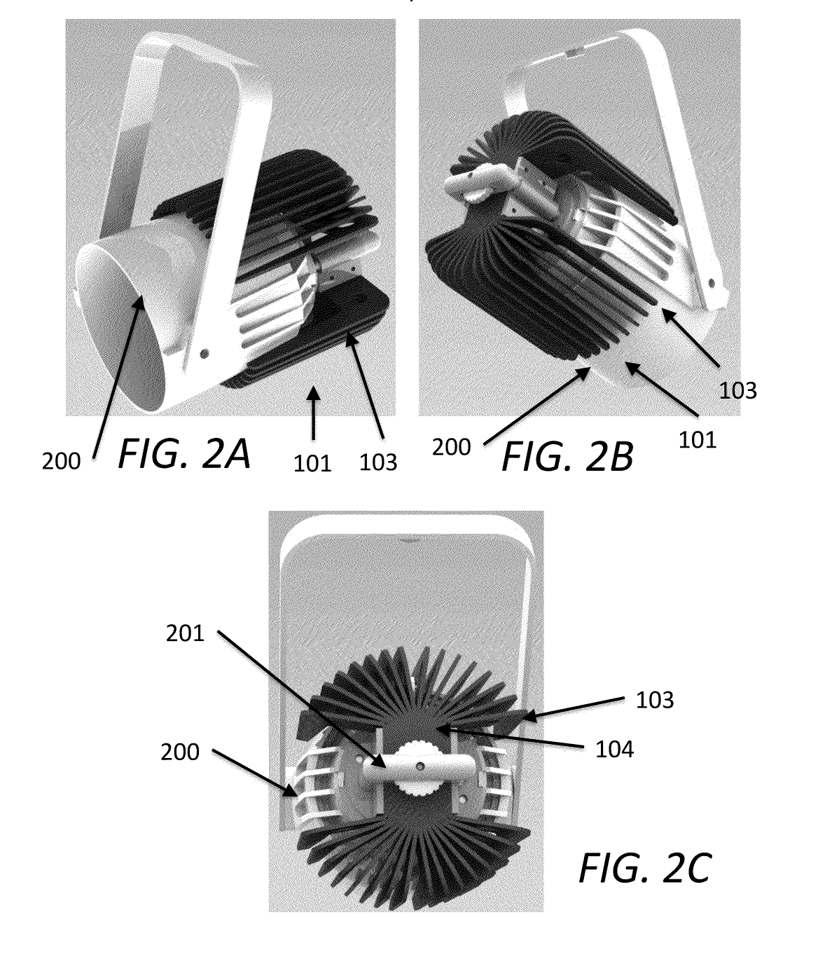

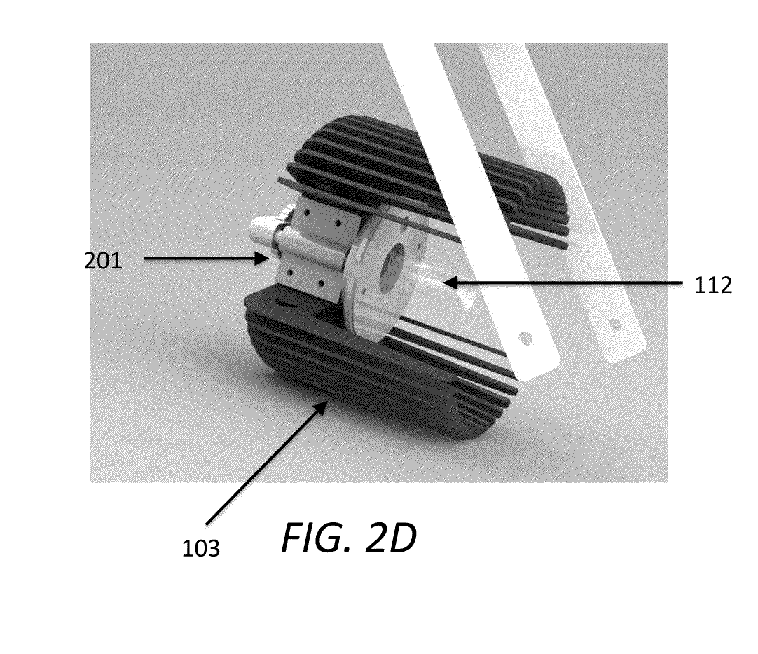

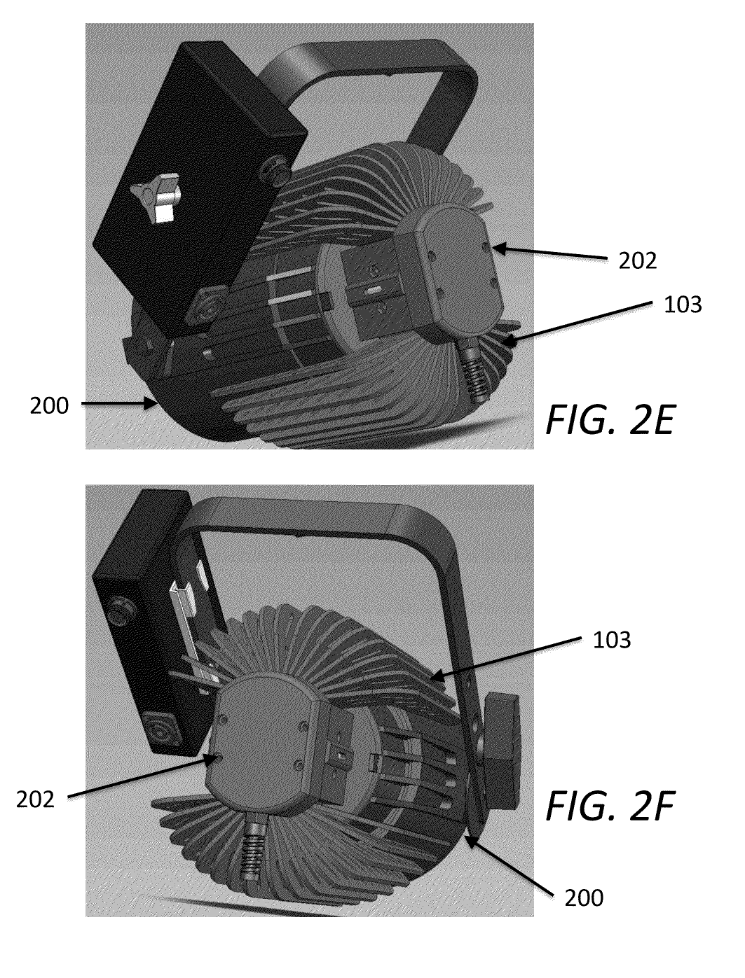

In some embodiments, as shown in FIG. 1F and further illustrated in FIGS. 2A-2E, the lamp 100 includes a fixture 200 in which the laminar heat sink formed from the thermally conducting plates 101 and the light source 105 are incorporated. The lamp reflector 111 may be incorporated in the fixture 200. The heat pipe 110 may be incorporated in the fixture 200. The fixture 200 may be a theater light fixture; in some embodiments, the theater light fixture is a typical light fixture, such as a four-filament theater lamp, an ellipsoidal spotlight, or other lamp unit with incandescent, halogen, or similar reflector-based lighting design. The lamp 100 may be incorporated into the light fixture 200 by inserting the portion of the lamp 100 that projects into the reflector 111 through the rear of the light fixture 200, with the heat dissipation structures 103 remaining external to the light fixture 200. In some embodiments, where the heat dissipation structures 103 are wings, the wings 103 slide around the exterior of the fixture 200. Where the wings are arrayed radially, as described above in reference to FIGS. 1A-1F, and the exterior of the fixture is cylindrical, the wings 103 may follow the exterior surface of the cylinder, creating an aesthetically pleasing and compact heat dissipation arrangement. The installation may be performed using a tool-less installation system as demonstrated in FIGS. 2A-2D; the elements used to perform the tool-less installation are shown without the light fixture in FIG. 2D. Ease of installation of the present invention is evident from the rear view in FIG. 2C, showing a simple tool-less installation onto a theater light fixture. In other embodiments, as shown in FIGS. 2E-2F, the installation is performed using fasteners; the fasteners may be fasteners as described above in reference to FIGS. 1A-1F. Either the tool-less installation or the installation using fasteners may be performed with any embodiments of the lamp described above in reference to FIGS. 1A-1F, including embodiments incorporating heat pipes 110 and embodiments including light guides 112. The lamp reflector 111 may be a lamp reflector 111 previously incorporated in the fixture 200.

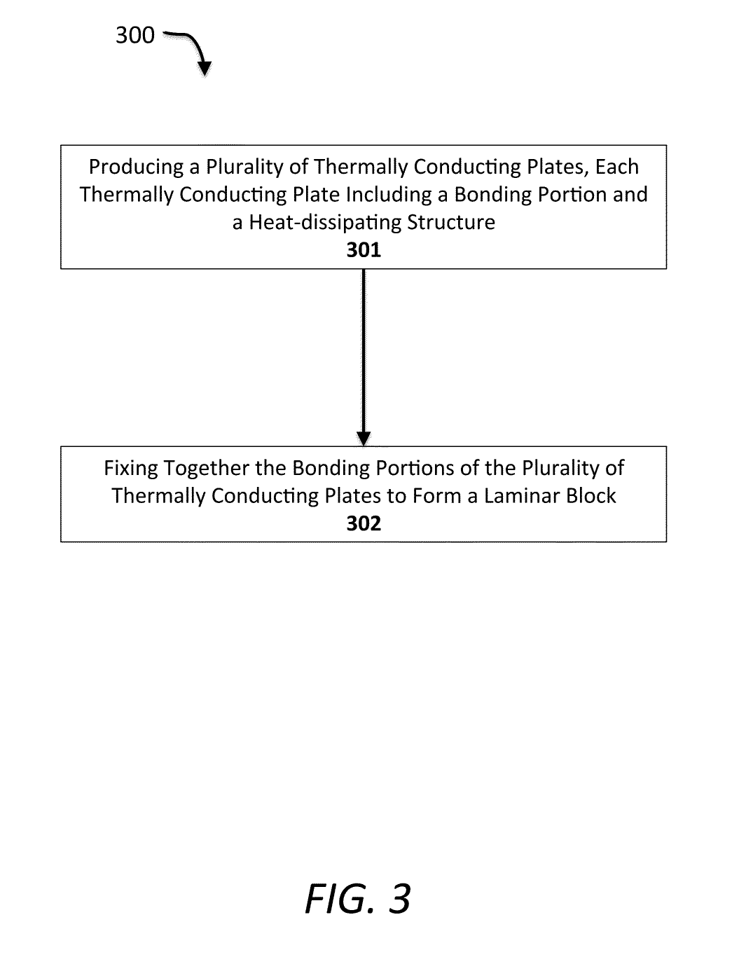

FIG. 3 is a flow chart illustrating one embodiment of the disclosed method 300 for manufacturing a laminar heat sink. As a brief overview, the method 300 includes producing a plurality of thermally conducting plates, each thermally conducting plate including a bonding portion and a heat-dissipating structure (301). The method 300 includes fixing together the bonding portions of the plurality of thermally conducting plates to form a laminar block (302).

In some embodiments, the laminar heat sink has the benefits of simplified manufacture when compared with extruded heat sinks, cast heat sinks, and billet heat sinks The laminar heat sink may be constructed more cheaply, in less time, and with less waste than competing designs. Cast heat sinks require creation of a mold and related tooling, which must be produced before production can begin and are often replaced periodically during manufacture. Extruded heat sinks similarly require customized tooling and equipment capable of operating the extrusion process at elevated temperature and/or pressures. Billet heat sinks are costly, often require costly 3-dimensional machining, and are considerably slower to produce than the disclosed laminar heat sink.

In further detail, and as further illustrated by 1A-2F, the method 300 involves producing a plurality of thermally conducting plates 101, each thermally conducting plate 101including a bonding portion and a heat-dissipating structure (301). In some embodiments, each plate 101 is produced by molding. In some embodiments, each plate 101 is cut from a sheet of material; the plate 101 may be cut from a sheet of material using lasers, high-powered water jets, saws, or machine tools, such as cutting tools. In some embodiments, each plate 101 is cut from a blank of material; the blanks may be identical. The plates 101 may be molded to form blanks, and then cut to add details, such as perforations 108, into the plates 101. In other embodiments, perforations 108 are produced in the molding process. The heat dissipation structures 103 may be formed separately and attached to the bonding portions 103; in other embodiments, the heat dissipation structures 103 and bonding portions 102 are formed together as a monolithic whole. For instance, the heat dissipation structures 103 and bonding portions 102 may be formed in a single mold. The heat dissipation structures 103 may be cut out of the same sheet or blank as the bonding portions 102 at the same time. In some embodiments, the molding process produces heat dissipation structures 103 that are angled; the heat producing structures 103 may be variously angled, as disclosed above in reference to FIGS. 1A-1F. In some embodiments, producing the plates 101 further involves bending the heat dissipation structures 103 to form angles, which may be various as disclosed above in reference to FIGS. 1A-1F; the bending may be accomplished by stamping the plates 101. Stamping the plates 101 or molding them may also produce various features of the surfaces 106a-b, 107a-b of the bonding portions 102. Molding or cutting may produce holes in the bonding portions 102 for fasteners.

The method 300 includes fixing together the bonding portions of the plurality of thermally conducting plates to form a laminar block 104 (302). For instance, first surface 106b of at least one first bonding portion 102b may be fixed against the second surface 107a of at least one second bonding portion 102a. The first surface 106b of the at least one first bonding portion 102b may be fused to the second surface 107a of the at least one second bonding portion 102a. The fusion may be accomplished by any suitable procedure; for instance first surface 106b may be adhered to the second surface 107a. The first surface 106b may be welded to the second surface 107a. The first surface 106b may be brazed to the second surface 107a. In other embodiments, the plurality of bonding portions 102 are fixed together using fasteners. The fasteners may be one or more rivets. The fasteners may be one or more screws. The fasteners may be one or more bolts. The fasteners may be one or more captive fasteners. The fasteners may be one or more clamps. The fasteners may be one or more ties.

Some embodiments of the method 300 further involve thermally connecting a light source 105 to the laminar block 104. The light source 105 may be thermally connected to the laminar block 104 by any means described above in reference to FIGS. 1A-1F.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A lamp with a laminar heat sink assembly, the lamp comprising:
a plurality of thermally conducting plates, each thermally conducting plate comprising a bonding portion and a heat-dissipating structure, the bonding portions of the plurality of thermally conducting plates fixed together to form a laminar block; and
a light source thermally connected to the laminar block.

2. A lamp according to claim 1, wherein each bonding portion of the bonding portions of the plurality of thermally conducting plates comprises a first surface and a second surface, and wherein the first surface of at least one first bonding portion is fixed against the second surface of at least one second bonding portion.

3. A lamp according to claim 2, wherein the first surface of the at least one first bonding portion is fused to the second surface of the at least one second bonding portion;

4. A lamp according to claim 1, wherein the plurality of bonding portions are fixed together using a plurality of fasteners.

5. A lamp according to claim 1, wherein the bonding portion of each of the plurality of thermally conducting plates is substantially flat.

6. A lamp according to claim 1, wherein the at least one heat dissipation structure of each heat conducting plate comprises at least one wing.

7. A lamp according to claim 6, wherein each wing has at least one perforation.

8. A lamp according to claim 6, wherein the wing of each thermally conducting plate projects from the laminar block at a different angle from each wing of each adjacent thermally conducting plate.

9. A lamp according to claim 8, wherein the wings are displaced radially around the laminar block.

10. A lamp according to claim 1 further comprising a fan positioned to blow air over the at least one heat-dissipating structure of at least one of the plurality of thermally conducting plates.

11. A lamp according to claim 1, wherein the light source is thermally connected to the laminar block by a heat pipe that contacts the laminar block and on which the light source is deployed.

12. A lamp according to claim 1, wherein the light source deployed against the laminar block.

13. A lamp source according to claim 1 further comprising a lamp reflector shaped to focus the light from the light source.

14. A lamp according to claim 13, wherein the light source is deployed within the lamp reflector.

15. A lamp according to claim 13 further comprising a light guide, the light guide comprising:
a total internal reflection conduit having a proximal end receiving substantially all light from the light source and a distal end projecting into the lamp reflector; and
a diffuse reflector, positioned at the distal end of the conduit, and shaped to reflect light back onto the lamp reflector.

16. A lamp according to claim 15, wherein the diffuse reflector is embedded in the distal end of the conduit, and wherein the diffuse reflector is further shaped to reflect light at an angle less than the critical angle of the conduit surface, so that the light passes through the conduit and strikes the lamp reflector.

17. A lamp according to claim 15, wherein the light source further comprises a reflective backing shaped to direct substantially all light emitted by the light source into the proximal end of the conduit.

18. A lamp according to claim 1, further comprising a light fixture in which the light source and plurality of thermally conducting plates are incorporated.

19. A method for manufacturing a laminar heat sink, the method comprising:
producing a plurality of thermally conducting plates, each thermally conducting plate comprising a bonding portion and a heat-dissipating structure; and
fixing together the bonding portions of the plurality of thermally conducting plates to form a laminar block.

20. The method of claim 19, further comprising thermally connecting a light source to the laminar block.
